(19) United States
(12) Patent Application Publication
(10) Pub. No.: US 2005/0010893 A1
(43) Pub. Date: Jan. 13, 2005

(54) Process for creating middleware adapters

(76) Inventors: John G.E. Schmidt, Minnetonka, MN (US); Richard A. Sorenson, Cologne, MN (US)

Correspondence Address: Beck & Tysver, P.L.L.C., Suite 100, 2900 Thomas Avenue S., Minneapolis, MN, 55416, US

(21) Appl. No.: 10/618,505

(22) Filed: Jul. 11, 2003

(51) Int. Cl. G06F 9/44

(52) U.S. Cl. 717/103

(57) ABSTRACT

In general, the disclosure is directed to a method of creating a middleware adapter in a factory. In one aspect, the method includes designing, developing and testing the adapter. The middleware adapter is designed with a designer and a quality controller to produce a design. Designing the middleware adapter includes reference to a knowledge base. The design is developed a developer and the quality controller to produce a requested adapter. The requested adapter is tested with a tester and the quality controller to produce a completed middleware adapter. In another aspect, the method includes analyzing a request for an adapter, designing the adapter, and developing the design. Analyzing the request includes determining whether the request is for a new adapter or for modifications to an existing adapter. Designing the adapter includes designing with a designer and a quality controller to produce a design, where the designing includes reference to a knowledge base. Developing the design includes developing with a developer and the quality controller to produce a requested adapter, where the developing includes coding the design, unit testing the requested adapter, and updating the knowledge base. Also, this aspect includes integration testing the requested adapter and system testing the requested adapter. In still another aspect, the disclosure is directed to factory for producing middleware adapters. The factory includes an assembly line for creating new middleware adapters and an assembly line for modifying existing adapters. Each assembly line includes designers, developers and testers working along the assembly line where each assembly line includes quality controllers working along with the designers, developers, and testers.

### REFERENCE TO CO-PENDING APPLICATION

This patent application claims priority to co-pending U.S. utility application for patent filed on Feb. 6, 2003, having Ser. No. 10/359,815, and titled “Creation of Middleware Adapters from Paradigms,” which claims priority to U.S. provisional application for patent filed on Feb. 8, 2002, having Ser. No. 60/355,256, and titled “Systems Integration and Middleware” and to U.S. provisional application for patent filed on Feb. 8, 2002, having Ser. No. 60/356,494, and titled “Systems Integration and Middleware”, and to U.S. provisional application for patent filed on Mar. 22, 2002, having Ser. No. 60/367,139, and titled “Systems Integration and Middleware.

This patent application also claims priority to co-pending U.S. utility application for patent filed on Feb. 6, 2003, having Ser. No. 10/359,969, and titled “Construction of Middlware Adapters”, which claims priority to U.S. provisional application for patent filed on Feb. 8, 2002, having Ser. No. 60/355,256, and titled “Systems Integration and Middleware” and to U.S. provisional application for patent filed on Feb. 8, 2002, having Ser. No. 60/356,494, and titled “Systems Integration and Middleware”, and to U.S. provisional application for patent filed on Mar. 22, 2002, having Ser. No. 60/367,139, and titled “Systems Integration and Middleware.”

The identified patent applications are incorporated by reference herein.

### BACKGROUND

The present disclosure relates to integration middleware. More particularly, the present disclosure relates to the process for creating adapters used to connect one application to another over integration middleware.

In order to meet the computing needs of a typical enterprise, it is necessary to operate numerous distinct computing platforms simultaneously. On each platform, separate software applications together handle the data processing needs of the enterprise. Although these applications and computer platforms are not generally designed to communicate with one another, it has long been recognized that some inter-program communication is required for an efficiently operating computing environment.

One class of software that allows such communication is known as integration middleware. This type of middleware allows events to be sent between a sending and a receiving application program through the use of integration objects. Events are also sometimes referred to as messages. When a first application wishes to communicate with a second application, the first application composes a event and places this event in the queue of the destination application. The event remains on the queues until it is received by the destination program, thereby providing asynchronous communication between the two applications. The integration broker portion of the middleware product handles all aspects of queue maintenance and event delivery. As a result, it is not necessary to build this capability into each of the application programs that communicate with each other.

It is necessary, however, to make sure that each application is able to send and receive events through the integration broker. This is accomplished through the use of adapters that operate between the application programs and the integration broker. The adapters convert communications emanating from the application into the events understood by the integration broker, and vice versa. In doing so, the adapters either communicate with the application program directly through the program's application program interface (or API), or are capable of extracting data from a file created and maintained by the application program.

In addition, each application will likely have its own particular format for data that it would like to share across an enterprise. Thus, it is usually necessary to transform the data being transmitted over a integration broker from the format of the sending application into a format understood by the receiving application. In some prior art middleware settings, this transformation occurs within the adapters, with each adapter being capable of converting between the data format of its application into a standard, canonical data structure defined for the enterprise as a whole. If the adapters do not have this ability, it is necessary for the integration broker itself to handle the data transformations.

In addition to data format transformation, it is sometimes necessary to perform additional actions on the data before it is transmitted between applications. For instance, data being transmitted over a middleware integration broker is often compressed for transmission efficiency. In addition, if the event is being sent over a public network or via other insecure means, it is prudent to encrypt the event prior to transmission. It may also be necessary to group short events together into a single transmission, or to chunk large events into several shorter transmissions. Regardless of whether a event is compressed, encrypted, grouped, or chunked after being sent by the sending application, it will be necessary to perform the opposite service before the event can be understood by the receiving application.

The steps of data transformation, compression, chunking, grouping, and encryption can be performed in only three locations, namely in the applications themselves, in the adapters, or in the middleware application. Locating these services in the applications would require significant application reprogramming. This would, of course, defeat the primary benefit of middleware systems, since middleware exists to allow inter-program communications without significant reprogramming. Instead, most prior art systems have placed the data transformation services in each adapter, and have performed the compression, chunking, grouping, and encryption services in the middleware product itself. In fact, many middleware products go so far as to perform the data transformations in the middleware product was well. Either way, the approach of placing most or all of these services in the middleware product creates “thin” adapters, meaning that the adapters have limited capabilities and complexities. All of the complexity is located in the “thick” middleware application. The use of thin adapters allows the adapter to be streamlined to focus on granting an application access to the interface format of the middleware, which in turn eases the creation of the numerous adapters that must be created in the traditional enterprise computing environment.

An unfortunate consequence of the use of thin middleware adapters is that an enterprise becomes reliant on the services performed by a particularly vendor's middleware application. Enterprises wishing to take advantage of these services must design their adapters to request the specific service from a particular middleware application. Since each vendor provides different levels of services, the enterprise becomes dependent on particular services being available using a particular interface. This occurs even where a vendor agnostic middleware interface such as Java Message Service (JMS) is used by the enterprise. What is needed to avoid the dependencies on middleware vendors is a reliable way of producing thick middleware adapters that incorporates these data services directly in the adapter without creating undue complexity that greatly increases the time to develop each adapter.

The design of a middleware adapter is an important consideration for an enterprise. The enterprise often considers the factors of cost and performance. These factors can be at odds with each other. An agnostic adapter may be relatively inexpensive, but questions of performance and compatibility arise. Agnostic adapters are often modified on site, thus adding to the cost. Custom-built adapters perform well but are often very expensive. Both adapters require maintenance, which adds to both the cost of the adapter and possible reduction in performance. These costs are multiplied by the number of adapters in the enterprise. For example, an enterprise may require hundreds of adapters. In addition, if the enterprise grows organically or through acquisitions, many more adapters are needed. What is needed is an efficient way to create and maintain middle-ware adapters.

### SUMMARY

The prevailing practice of building middleware adapters is to either build adapters using a product methodology with the intention of having the same adapter used many times, or to build adapters using a custom build methodology with the intention of using the adapter for a single specific purpose. Generally, middleware vendors or application vendors use the product methodology approach while consulting firms or in-house Information Systems departments use the custom build methodology. The present disclosure is directed to a novel process of creating middleware adapters that can be adapted for specific applications.

In general, the disclosure is directed to a method of creating a middleware adapter in a factory. In one aspect, the method includes designing, developing and testing the adapter. The middleware adapter is designed with a designer and a quality controller to produce a design. Designing the middleware adapter includes reference to a knowledge base. The design is developed a developer and the quality controller to produce a requested adapter. The requested adapter is tested with a tester and the quality controller to produce a completed middleware adapter. In another aspect, the method includes analyzing a request for an adapter, designing the adapter, and developing the design. Analyzing the request includes determining whether the request is for a new adapter or for modifications to an existing adapter. Designing the adapter includes designing with a designer and a quality controller to produce a design, where the designing includes reference to a knowledge base. Developing the design includes developing with a developer and the quality controller to produce a requested adapter, where the developing includes coding the design, unit testing the requested adapter, and updating the knowledge base. Also, this aspect includes integration testing the requested adapter and system testing the requested adapter. In still another aspect, the disclosure is directed to factory for producing middleware adapters. The factory includes an assembly line for creating new middleware adapters and an assembly line for modifying existing adapters. Each assembly line includes designers, developers and testers working along the assembly line where each assembly line includes quality controllers working along with the designers, developers, and testers.

The process includes many advantages and features. Among these Key features include high re-use of adapter component building blocks, low cost to design and build each adapters, rapid development using assembly line techniques, knowledge-based repository of important information about each adapter, and effective hand-off of factory processes to different individuals wherever they are around the world to support 24-hour per day continuous assembly-line processing.

### BRIEF DESCRIPTION OF THE FIGURES

FIG. 1 is a schematic diagram of a first example of a middleware adapter environment illustrating a first mode of communication.

FIG. 2 is a schematic diagram of a second example of a middleware adapter environment illustrating a second mode of communication.

FIG. 3 is a schematic block diagram of components of an adapter suitable for use in the examples of FIG. 1 and FIG. 2.

FIG. 4 is a block diagram of a process for creating middleware adapters.

FIG. 5 is a block diagram of a factory suitable for performing the process of FIG. 4.

FIG. 6 is a block diagram of a more detailed example of the process of FIG. 4.

FIG. 7 is a block diagram of an example of an aspect of the process of the present disclosure.

### DESCRIPTION

This disclosure relates to the process for creating adapters. The disclosure, including the figures, describes the process with reference to a several illustrative examples. Other examples are contemplated and are mentioned below or are otherwise imaginable to someone skilled in the art. The scope of the invention is not limited to the few examples, i.e., the described embodiments of the invention. Rather, the scope of the invention is defined by reference to the appended claims. Changes can be made to the examples, including alternative processes not disclosed, and still be within the scope of the claims.

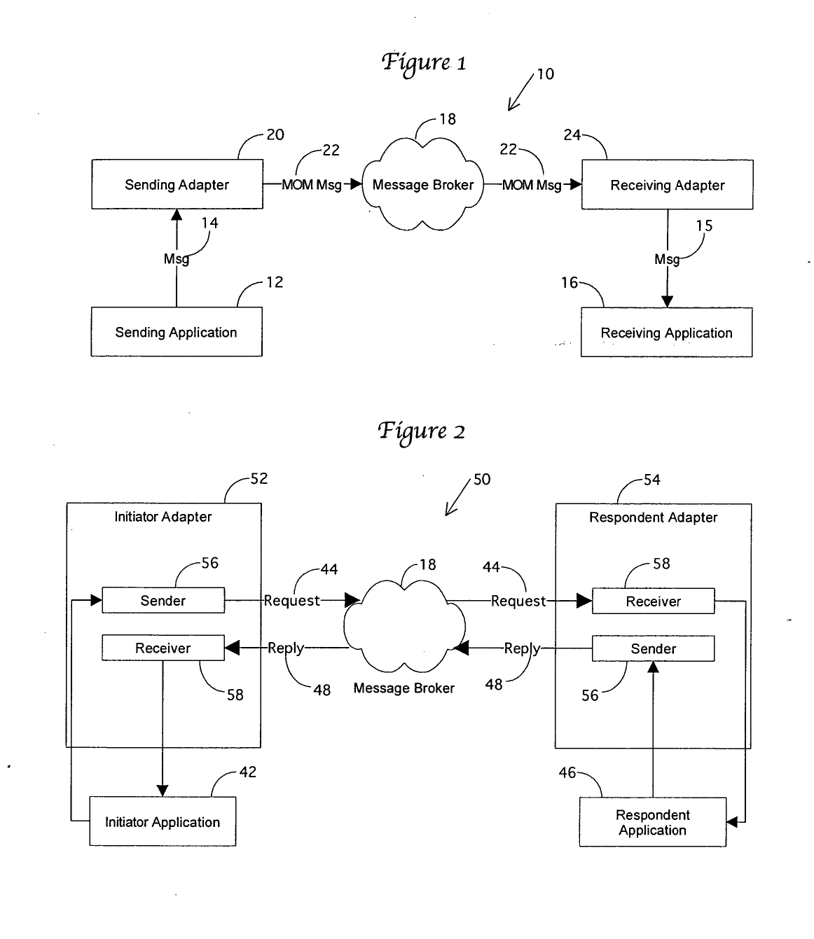

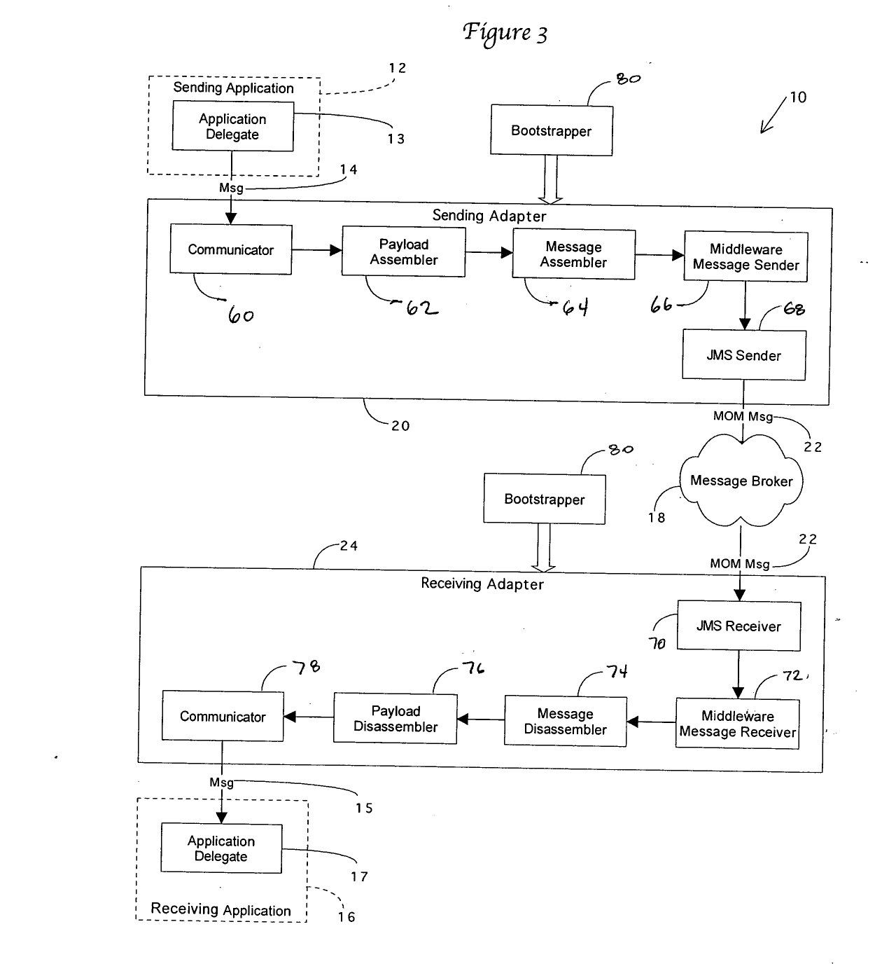

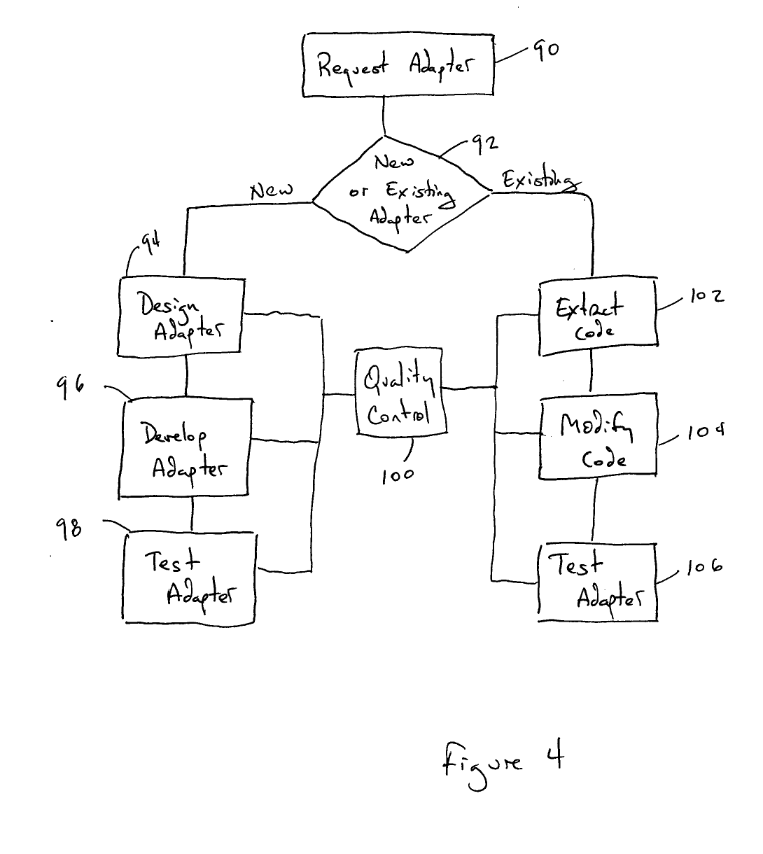

FIGS. 1 and 2 describe examples of communication using adapters. FIG. 3 describes an example of the components of the adapters of FIGS. 1. Other examples of communications and adapters, either known or unknown are contemplated and are still within the scope of the present disclosure.

FIG. 1 is a schematic representation of one example of a point-to-point communication 10 in which a sending application 12 sends a message 14 to a receiving application 16 over a integration broker 18. The integration broker 18 can be provided by any of the widely available message-oriented middleware products, such as WebSphere® MQ (formerly known as MQSeries®) from IBM (Armonk, N.Y.). The integration broker 18 expects the messages it delivers to be presented in a particular format that is likely unknown to the sending application 12. The sending application 12 uses a sending adapter 20 to receive the message 14 and convert it into a format 22 acceptable to the message-oriented middleware (MOM) integration broker 18. The receiving application 16 uses a receiving adapter 24 to accept the MOM formatted message 22 from the integration broker 18, and convert it into a message format 15 that is understood by the receiving application.

A particular adapter can be responsible for both sending and receiving a message over the integration broker 18. One such example is shown in FIG. 2 where an initiator application 42 sends a request 44 for particular data to a respondent application 46. The respondent application 46 receives the request 44, and responds with a reply message 48 containing the data desired by the initiator application 42. The integration broker 18 in the example is oblivious to the fact that it is being used to conduct a request/reply interaction 50. From the point of view of the broker 18, the communication 50 is simply the combination of two separate two point-to-point interfaces: one originating at the initiator application 42 and the second originating at the respondent application 46. The intelligence for handling this transaction as a request and reply paradigm communication is found within the adapters 52, 54 and applications 42, 46. The initiator adapter 52 contains a both sender component 56, which sends the request 44 to the integration broker 18, and a receiver component 58 for receiving the reply 48. The respondent adapter 54 contains a receiver 58 for receiving the request 44, and a sender 56 for sending the reply 48.

FIG. 3 is a block diagram showing the details of the sending adapter 20 and receiving adapter 24 of communication 10. Sending adapter 20 receives a message 14 from the sending application 12, and converts it to a MOM message 22 understood by the integration broker 18. This is accomplished using numerous components that process and massage the message 14 into the MOM format message 22. These components receive the message from the sending application 12, convert the data into the appropriate XML format and schema, compress the message, add a message header, handle any desired encryption, chunking, or grouping, and submit the message to the integration broker 18 using JMS.

The first component shown in FIG. 3 is the communicator 60. This component is responsible for all communication with the sending application 12. More specifically, the communicator 60 is responsible for communication with an application delegate 13, which is an interface designated by the sending application 12. The application delegate 13 could be the standard API (application program interface) for the application 12. Alternatively, the application delegate 13 could be a data file maintained and accessed by the application 12 for the sole purpose of communicating with the adapter 20 and the integration broker 18.

The message 14 sent through the application delegate 13 will contain data about a specific data topic. That is, the data elements in the message 14 will relate to a single, logical data structure or object defined for an enterprise, such as a customer, a shipment, or a product. The message 14 will generally format this data in the same data format used by the sending application 12. The communicator 60 is responsible for understanding this data format and converting the data into a raw XML data format.

The payload assembler 62 takes this raw XML data and converts it to a standard, canonical XML that the enterprise has previously defined for the data topic. The payload assembler 62 then validates this canonical XML against a predefined schema, and presents this validated, canonical XML data to the message assembler 64.

The message assembler 64 is responsible for compressing the data message received from the payload assembler 62 and then adding the message header that is expected by the integration broker 18. The middleware message sender 66 then is able to provide the encryption, chunking, or grouping services that are desired for this message 14. Once these services are applied to the message, it is submitted to the JMS sender 68, which formats the message into the JMS standard for submission to the integration broker 18 as MOM message 22.

The integration broker 18 delivers the MOM message 22 to the receiving adapter 24, which then processes the MOM message 22 into a format 15 understood by the receiving application 16. This is accomplished using the same basic components used in the sending adapter 20, except that the components in the receiving adapter 24 perform the opposite functions. The JMS receiver 70 receives the JMS formatted message 22 and delivers it to the middleware message receiver 72. The receiver 72 must decrypt, ungroup, and de-chunk the message as necessary based upon the services performed on the message 22 when it passed through middleware message sender 66. Because the middleware message receiver 72 must know what happened in the sending adapter 20, it is generally necessary to create the sending and receiving adapter 20, 24 in pairs. The middleware message sender 66 and the middleware message receiver 72 will both know which services will be performed on the MOM messages 22, and will be able to share such things as the encryption/decryption keys that is used.

Once the middleware message receiver 72 ungroups and decrypts the received MOM message, the message disassembler 74 removes the header from the message and decompresses the data payload. The payload is then provided to the payload disassembler 76, which is responsible for taking the canonical XML created by the payload assembler 62 and converting it back into raw XML data. The communicator 78 of the receiving adapter 24 then converts the raw XML data back into the native format of the receiving application 16. Once the data is so converted, it is presented to the application delegate 17 of the receiving application 16 as message 15. This application delegate 17 is much like the application delegate of the 13 of the receiving application 12, in that the delegate 17 can range from a data file accessed by the receiving application 12 to the standard API of the receiving application 12.

FIG. 3 also shows two components labeled bootstrapper 80. The bootstrapper 80 is responsible for starting the adapter 20 at the appropriate time. The bootstrapper 80 may form part of the application program 12, may be a specialized program whose sole purpose is to launch adapter 20, or may even be a centralized program that monitors and manages numerous adapters 20, 24 throughout an entire enterprise.

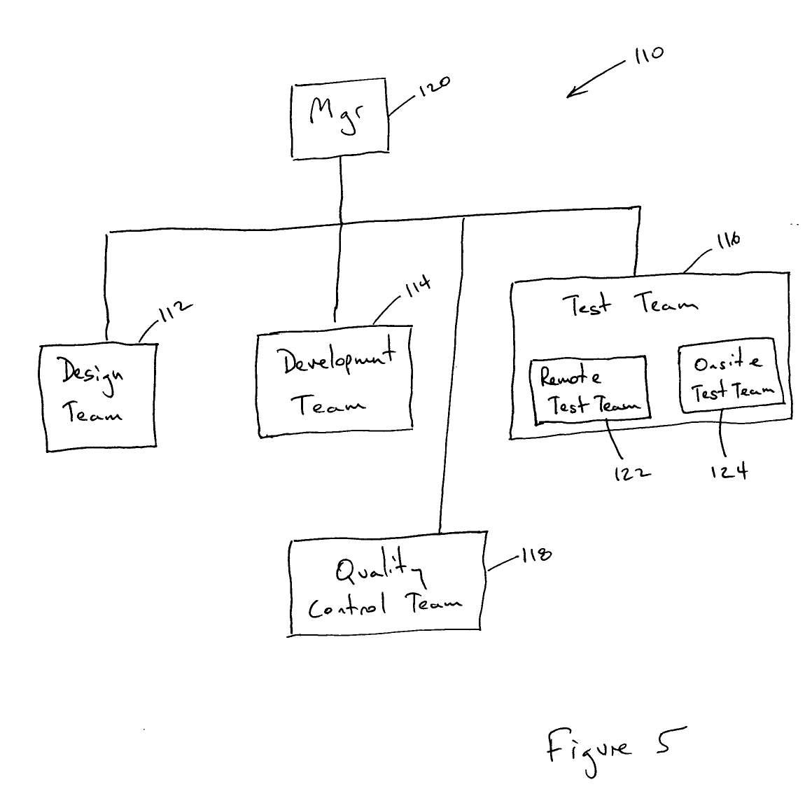

An overview of a process for creating middleware adapters is shown in FIG. 4. In the process, a customer will request an adapter 90. Separate assembly lines are provided depending whether the requested adapter is new or is a modification to an existing adapter 92. If the requested adapter is a new adapter, the adapter is designed 94 in the example. The designed adapter is developed 96 and tested 98. Design 94 and development 96 typically occur at a site remote to the customer, i.e., a remote site. Testing 98 can occur both at the site of development, i.e., the remote site, and at the customer's site. Quality control 100 is provided at the remote site. If the requested adapter is a modification to an existing adapter, the code related to the adapter will be extracted from a version control tool 102. The code will be changed 104 and the modified adapter will be tested 106.

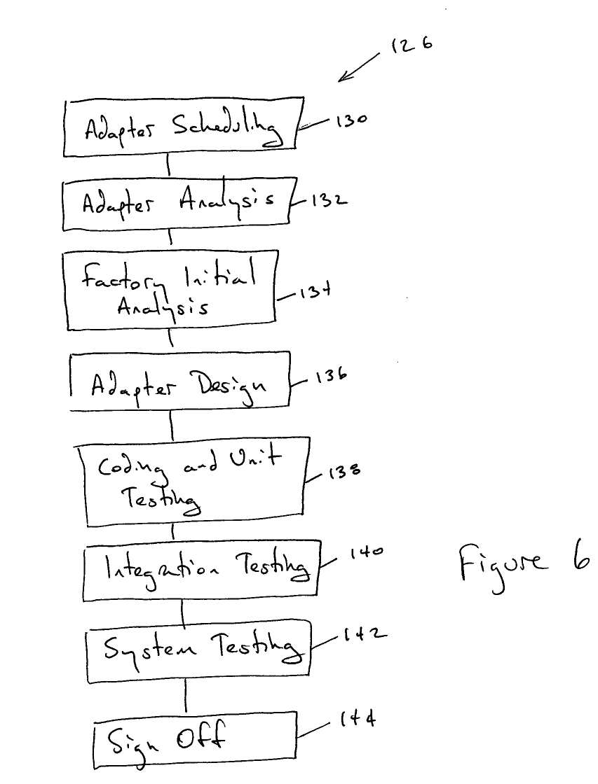

The creation of middleware adapters is performed at a factory, indicated as 110 in FIG. 5. The factory can be located anywhere in the world and is operably couple to the customer. In one example, the factory is linked over a wide area network to the customer. In this example, the factory includes a design team 112, a development team 114, a test team 116, and a quality control team 118, all which report to a remote site manager 120. A team in this example can include one person who is not exclusive of another team. In one example, however, each team consists of several individuals who are assigned to exclusively work with the team. The each team can include a core team of individuals who are assigned to the team regardless of the workload. The core team thus can include the minimum number of individuals that maintain the operation of the team. At idle times, the core team can include more individuals than necessary to accommodate the workload. Temporary individuals can be added to each team depending on staffing needs of the team, such as increased workload.

The design team 112 can be responsible for all designs of the factory. All design requests to the factory will be routed to the design team. In one example, the design team will include a design manager for every five designer. The design manager can report to the remote site manager. If the number of designers falls to less than five, in this example, the remote site manager can perform the function of the design manager. Once a design is complete, the request is passed to the development team.

The development team 114 can be responsible for adapter coding, XSL development and unit testing. In one example, the development team will have a lead developer for every ten developers. If the number of developers falls to less than ten, the remote site manager can perform the role of the lead developer. When the development is completed, the request is passed to the test team.

The test team 116 includes individuals located at the remote site and the customer's site, or the remote test team 122 and the onsite test team 124, respectively. In one example, the remote team performs the majority of testing. In this case, the remote site, or factory, does not get access to the source and target deployment systems. The testing team will do the testing of all feeds consisting of one or more adapters, and will set up the test environment and deploy adapters for the feed.

The quality control team 118 reviews all deliverables from the factory, and they ensure that all processes are followed throughout the lifecycle. The team will ensure that all deliverables are of acceptable quality. Each adapter request is allocated one quality team member. In one example, one quality team member is provided for a development team of five and a design team of two. In the figure, the design, development and testing teams are indicated in series with one another. That is, a deliverable is passed from one group to the next in succession. The quality team works in parallel with these groups, alongside each one as the deliverable is passed from group to group. In one example, the quality team works with the remote test team and not the onsite test team, although other configurations are possible.

Items measured by the quality control team include productivity or effort spent on the adapter, turn around time, effectiveness, schedule deviation, effort deviation, field error rate, wait time or unproductive hours in adapter development, and cost per adapter development. Other items are contemplated.

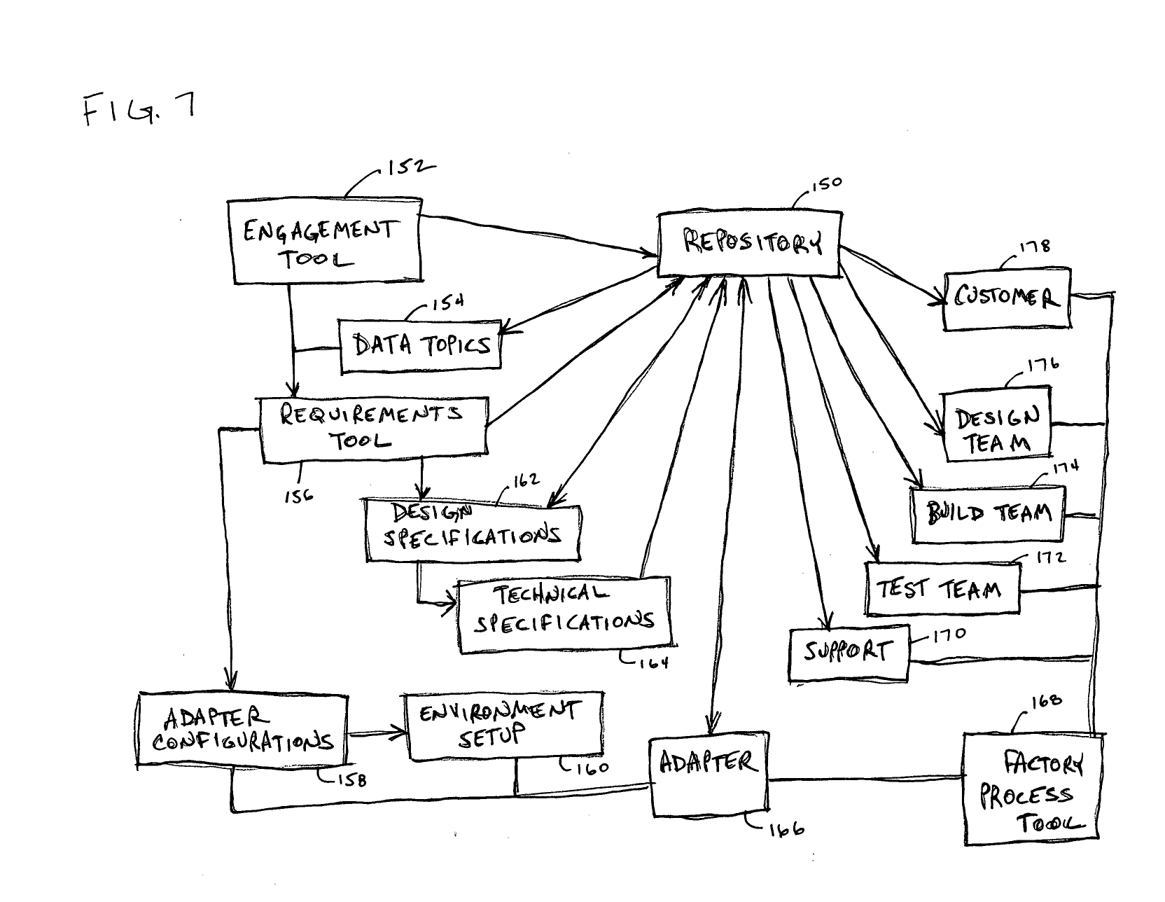

The development lifecycle 126 is set forth in FIG. 6. In general, the lifecycle 126 includes adapter scheduling 130, adapter analysis 132, factory initial analysis 134, adapter design 136, coding and unit testing 138, integration testing 140, system testing 142, and sign off 144. The development lifecycle 126 in the example generally covers both new adapters and modifications to existing adapters, i.e., adapter maintenance. In the example, however, new adapters and adapter maintenance are performed in separate assembly lines. Differences in the assembly lines can now be understood by those with skill in the art, and some differences are highlighted below.

Adapter scheduling 130 is the task that controls adapter development inflow to the factory 110. In one example, scheduling 130 does not come within the scope of the factory's processes. In another example, scheduling 130 is performed by the factory. In the example, adapter scheduling prioritizes the adapter development tasks across projects according to resource availability and delivery dates. Other criteria for prioritization are contemplated. In the example, the scheduler receives all information about all new adapter development activities that are expected and aids in the plans for development. One task of the scheduler is to make projections about expected resource requirements. Based one these projections, the remote site manager may make modifications to the number of temporary individuals to aid the core team.

Adapter analysis 132 is performed, typically, onsite. An onsite technical group can perform the adapter analysis. The general purpose of the analysis is to review a requirement specification document. The general deliverables generated from this step include the requirements specification, reviewed data mapping, and sample extract data are provided. The onsite technical group can review the detailed adapter requirement specification document, in consultation with the project team and engagement architect, collect sample extract data wherever applicable, check whether the current features of the framework support the adapter requirements, analyze if the adapter design is fit for design in the factory mode and initiate the offshore request through the scheduler.

The technical group can also check whether the adapter design requires changes to the framework. If the adapter calls for changes in the adapter core framework, a technical group member will raise a change request to the remote site core team and will work them to finalize the adapter design. Once the design is done, adapter development request will be sent to the remote site, through the scheduler.

Additionally, the analysis 132 can identify the source and target systems and applications and raise network connectivity request for the factory to access the servers/applications. The analysis should check if there are security concerns in granting the factory access to the source and target systems. In such cases integration testing needs to be done onsite and the scheduler need to be informed about this need.

In the example, factory initial analysis 134 is the entry step performed in the factory. The request for an adapter is diverted into one of two assembly lines (as indicated in FIG. 4), i.e., a development assembly line for new adapters or a maintenance assembly line for changes to completed adapters. The timing and resource allocation set by the scheduling 130 is confirmed. In addition, the connectivity of the source and target systems with the remote site is confirmed.

Adapter development includes the steps of adapter design 136 and coding and unit testing 138. In the case of design 136, a search is performed of a knowledge base to determine if a similar type of requested adapter has already been developed. If a similar type has been developed, the design and code is reused for the requested adapter. In the case of a new design, the designers will refer to the design documentation. Afterwards, the knowledge base is updated. Coding 138 involves develops Java code and XSLs. Base line versions of an adapter are used. Testing is developed for entire code coverage. For each adapter, Junits or test cases are used. If the java code is reusable, Junits are used. In the example, Junits are not used for testing XSLs. The knowledge base is updated with any encountered problems and solutions.

The test team 116 in the factory, the remote test team 122, will perform the integration testing 140. At times, the remote test team 122 with interface with the onsite test team 124 for this step. The test team 116 working on the project will obtain the code developed in step 138 and deploy the code on the source and target systems. The test team 116 develops test cases that cover end-to-end functionality testing. The test team will deploy the integration tested code into the adapter environment, and onsite personnel will perform system testing 142. Once the adapter is tested, it is prepared for delivery and the factory has completed its function in the example, and will sign off 144.

FIG. 7 is a block diagram showing a knowledge base 148. The knowledge base includes a repository 150 and a plurality of tools. In the example, the tools include input tools, input/output tools, and output tools. The knowledge base is applied in the process, as mentioned above. The knowledge base functions as a repository of information gathered throughout applications of the process shown above. In the example, information gathered in the engagement tool 152 is provided to and stored in the repository 150. This information, in the example, is typically high level requirements of the adapter provided to the factory from the customer. This information can include such high level requests as when the adapter is needed, how many adapters are required, and the like. The base 150 can provide a feed for the purposes of design of the adapter at data topics 154. The data topics can include information regarding the high level purpose of the adapter, such as whether it is for inventory, sales, employee relations, or the like. Information from the engagement tool 152 and data topics 154 are provided to the designer, as is further information from the customer at the requirements tool 156. The requirements tool 156 asks for more detailed and technical information about the adapter requirements than the engagement tool 152. In one example, the requirements tool 156 requests information at the business operations level. The information input into the requirements tool is provided to the repository 150.

After information is input into the requirements tool 156, the adapter development can take one of a plurality of paths. In the example shown, two paths are possible. The first path is taken when the adapter meets simple adapter specifications, such as when the adapter has previously been built with the process and input into the repository. In this case, the adapter might still need configuring. The first path leads to the adapter configuration tool 158 for application-specific configuration. An environment setup tool 160 can also be applied, which receives and applies specific information about the particular adapter environment. The second path is taken when a very similar adapter is not already in the repository 150. In this case, detailed technical information is input into the design specifications tool 162, which is then provided into the repository. The technical specifications tool 164 receives further technical information regarding the application of the environment, such as information regarding the servers operation the adapter and other information about the environment. This information is also provided into the repository 150. Based on the inputs and exchanges of information with the tools, the repository provides an adapter 166 to the process. Additional building of the provided adapter 166 is input into the repository.

In the example shown, the repository 150 can also generate a set of reports for insight into the factory process in connection with a tool 168 having information related to the factory process. The reports in the set are customized to the intended audience. In the example, reports can include a support view 170, a test team view 172, a build team view 174, a design team view 176, and a customer view 178. These reports provide audience-specific information to aid in the creation of the adapter, and can provide information regarding the progress of the adapter.

The present invention has now been described with reference to several embodiments. The foregoing detailed description and examples have been given for clarity of understanding only. Those skilled in the art will recognize that many changes can be made in the described embodiments without departing from the scope and spirit of the invention. Thus, the scope of the present invention should not be limited to the exact details, steps, sequences and structures described herein, but rather by the appended claims and equivalents.

1. A method of creating a middleware adapter in a factory, the method comprising:
designing the middleware adapter with a designer and a quality controller to produce a design, wherein the designing includes reference to a knowledge base;
developing the design with a developer and the quality controller to produce a requested adapter;
testing the requested adapter with a tester and the quality controller to produce a completed middleware adapter.

2. The method of claim 1 wherein the designing a middleware adapter is one of designing a new middleware adapter and modifying an existing middleware adapter.

3. The method of claim 1 wherein the middleware adapter is included in an adapter environment, and the factory is remotely located from but operably coupled to the middleware environment.

4. The method of claim 3 wherein the testing is performed at the factory and at the adapter environment.

5. The method of claim 1 wherein the knowledge base includes a repository and a plurality of input tools.

6. The method of claim 5 wherein the knowledge base includes an input/output tool.

7. The method of claim 6 wherein the input/output tool is a design specification tool.

8. The method of claim 5 wherein the input tools include an engagement tool, a requirements tool, and a technical specifications tool.

9. A method of creating a middleware adapter in a factory, the method comprising:
analyzing a request for an adapter, wherein analyzing the request includes determining whether the request is for a new adapter or for modifications to an existing adapter;
designing the adapter with a designer and a quality controller to produce a design, wherein the designing includes reference to a knowledge base;
developing the design with a developer and the quality controller to produce a requested adapter, wherein the developing includes coding the design, unit testing the requested adapter, and updating the knowledge base;
integration testing the requested adapter; and
system testing the requested adapter.

10. A factory for producing middleware adapters, the factory including:
an assembly line for creating new middleware adapters; and
an assembly line for modifying existing adapters;
wherein each assembly line includes designers, developers and testers working along the assembly line, and wherein each assembly line includes quality controllers working along with the designers, developers, and testers.

11. The factory of claim 10 wherein the assembly line workers can be located in different parts of the world.

12. The factory of claim 11 wherein the assembly process is performed at a different factory location.
